(19) United States
(12) Patent Application Publication
(10) Pub. No.: US 2007/0222777 A1
(43) Pub. Date: Sep. 27, 2007

(54) ELECTROOPTIC DEVICE, WIRING BOARD, METHOD FOR MANUFACTURING ELECTROOPTIC DEVICE, AND ELECTRONIC DEVICE

(75) Inventor: Masahiko NAKAZAWA, Matsumoto-shi (JP)

Correspondence Address: LOWE HAUPTMAN BERNER, LLP, 1700 DIAGONAL ROAD, SUITE 300, ALEXANDRIA, VA, 22314, US

(73) Assignee: SANYO EPSON IMAGING DEVICES CORPORATION, Tokyo (JP)

(21) Appl. No.: 11/683,990

(22) Filed: Mar. 8, 2007

(30) Foreign Application Priority Data
Mar. 8, 2006 (JP) 2006-062151

(51) Int. Cl. G09G 5/00

(52) U.S. Cl. 345/205

(57) ABSTRACT

An electrooptic device includes: a first substrate including a first terminal group having a plurality of first terminals and a second terminal group having a plurality of second terminals; a second substrate including a third terminal group having a plurality of third terminals that are conductively connected to the plurality of corresponding first terminals; and a third substrate including a fourth terminal group having a plurality of fourth terminals that are conductively connected to the plurality of corresponding second terminals. The plurality of first terminals extend along a plurality of lines passing through a first common point apart from the first terminal group in a predetermined direction intersecting the direction of the array of the first terminals and are arrayed in line symmetry about an axis passing through the first common point. The plurality of second terminals extend along a plurality of lines passing through a second common point apart from the second terminal group in a predetermined direction intersecting the direction of the array of the second terminals and are arrayed in line symmetry about an axis passing through the second common point.

The entire disclosure of Japanese Patent Application No. 2006-062151, filed Mar. 8, 2006 is expressly incorporated by reference herein

### BACKGROUND

1. Technical Field

The present invention relates to an electrooptic device, a wiring board, a method for manufacturing the electrooptic device, and an electronic device, and in particular, it relates to a mount structure in which terminal groups including multiple terminals are conductively connected to each other.

2. Related Art

Known electrooptic devices mounted to electronic devices such as portable phones, notebook computers, and TV sets have a structure including an electrooptic panel such as a liquid-crystal display panel and a flexible wiring board mounted to the electrooptic panel. When a driving circuit for driving the electrooptic panel is mounted to the panel, the flexible wiring board supplies display data and control signals sent from the display control system of the electronic device to the electrooptic panel. When the driving circuit is not mounted to the electrooptic panel, the driving circuit is mounted to the flexible wiring board or another circuit board to which a flexible wiring board is connected. In such cases, the flexible wiring board supplies a driving signal output from the driving circuit to the electrooptic panel.

The above structure is such that multiple input terminals are arrayed in a row along a rim of the electrooptic panel, while multiple connecting terminals are arrayed in a row along a rim of the flexible wiring board in correspondence with the input terminals. When the flexible wiring board is mounted to the electrooptic panel, the input terminal row and the connecting terminal row are opposed with an anisotropic conductive film (ACF) or the like in between, to which heat or pressure is applied with a tool to bring the corresponding input terminals and connecting terminals into conductive connection.

The connecting terminal row of the flexible wiring board is in exact correspondence with the input terminal row of the electrooptic panel. However, since the flexible wiring board is mainly formed of polyimide resin, it expands or contracts greatly because of temperature changes or moisture absorption, thus changing the terminal pitch of the connecting terminal row. This causes deviations in array pitch between the connecting terminal row and the input terminal row on the glass substrate that is little influenced by temperature changes or moisture absorption to bring the connecting terminals and the input terminals out of agreement with each other, thus causing mount failure.

Thus, there is proposed a terminal structure and a method for mounting in which the multiple input terminals and the multiple connecting terminals are arranged linearly along multiple lines that pass through common points arranged apart in a predetermined direction and intersecting the direction of the array of the input terminal row and the connecting terminal row so that even if the array pitch of the connecting terminal row changes to some extent because of the expansion or contraction of the flexible wiring board, the array pitches can be agreed to each other by relatively shifting the input terminal row and the connecting terminal row in the direction in which the distances from the common points change (e.g., refer to JP-A-2003-258027).

On the other hand, known electrooptic devices including an electrooptic panel have a flexible wiring board connected to an electrooptic panel and a circuit board connected to the flexible wiring board. This type of flexible wiring board generally includes a semiconductor chip having a driving circuit and other electronic parts on a circuit board, and uses a flexible wiring board for conductively connecting the circuit board to the electrooptic panel.

Electrooptic devices including two or more electrooptic panel are also known. For example, electrooptic devices are proposed in which a driving circuit is mounted on one electrooptic panel itself or on a wiring board connected thereto, and the electrooptic panel and the other electrooptic panel are conductively connected to each other by a flexible wiring board (e.g., refer to JP-A-9-269498 and JP-A-2003-177684).

However, in the case in which the electrooptic panel and the circuit board are connected together by the flexible wiring board and the case in which two electrooptic panels are connected together by the flexible wiring board, the connection structures are complicated and the terminal array pitch is narrow. This needs to ensure electrical reliability of the whole electrooptic device, and to reduce the size of the entire device and variations in size, and to improve the workability of assembly.

### SUMMARY

Advantages of some aspects of the invention are that there is provided a structure in which the electrical reliability of a device in which multiple electronic components are connected to one electronic component can be ensured, and in addition, there is provided a structure in which the size of the device and variations in size are reduced, and the workability of assembly is improved.

According to a first aspect of the invention, there is provided an electrooptic device comprising: a first substrate including a first terminal group having a plurality of first terminals and a second terminal group having a plurality of second terminals; a second substrate including a third terminal group having a plurality of third terminals that are conductively connected to the plurality of corresponding first terminals; a third substrate including a fourth terminal group having a plurality of fourth terminals that are conductively connected to the plurality of corresponding second terminals. The plurality of first terminals extend along a plurality of lines passing through a first common point apart from the first terminal group in a predetermined direction intersecting the direction of the array of the first terminals and are arrayed in line symmetry about an axis passing through the first common point. The plurality of second terminals extend along a plurality of lines passing through a second common point apart from the second terminal group in a predetermined direction intersecting the direction of the array of the second terminals and are arrayed in line symmetry about an axis passing through the second common point.

The first substrate has a first terminal group and a second terminal group. The first terminals of the first terminal group extend along a plurality of lines passing through a first common point. The second terminals of the second terminal group extend along a plurality of lines passing through a second common point. Moreover, the second substrate has a third terminal group corresponding to the first terminal group, and the third substrate has a fourth terminal group corresponding to the second terminal group. Accordingly, even if the terminal pitch is narrow, the second substrate and the third substrate can be mounted to the first substrate without disagreement of the terminals, thus improving the electrical reliability of a device having a complicated mount structure with a high-density terminal array.

It is preferable that the first terminal group and the second terminal group be disposed along the opposite outer rims of the first substrate. This allows the positioning of the first substrate and the second substrate and the positioning of the first substrate and the third substrate in the same direction, thus improving the mounting workability.

It is preferable that the first common point apart from the first terminal group and the second common point apart from the second terminal group be disposed on the same side. Thus, when the array pitch of the terminals of the first substrate fluctuates because of the expansion or contraction of the first substrate, fluctuations in the overlapping range of the mount region of the first terminal group and the third terminal group and fluctuations in the overlapping range of the mount region of the second terminal group and the fourth terminal group become opposite. This makes it difficult to change in the length from the second substrate through the first substrate to the third substrate, thus reducing size changes due to positioning for mounting. This reduces variations in size of the electrooptic device, facilitating and ensuring mounting of the electrooptic device to electronic devices.

It is preferable that the first common point apart from the first terminal group and the second common point apart from the second terminal group be disposed on the opposite sides. Since the first terminal group and the second terminal group are constructed in symmetry, the second and third substrate can be mounted irrespective of the position of the first substrate (even if the first terminal group and the second terminal group are used inversely).

In this case, it is preferable that the first common point for the first terminal group be disposed on the side of the second terminal group, and that the second common point for the second terminal group be disposed on the side of the first terminal group. Fluctuations in the distance between the first terminal group and the second terminal group and fluctuations in the overlapping range of the mount region of the first terminal group and the third terminal group and the mount region of the second terminal group and the fourth terminal group correspond to each other. This makes it difficult to change in the length of the range from the second substrate through the first substrate to the third substrate, thus reducing size changes due to positioning for mounting. This reduces variations in size of the electrooptic device, facilitating mounting of the electrooptic device to electronic devices.

It is preferable that the first common point for the first terminal group and the second common point for the second terminal group be apart from the first substrate. Thus, when the first substrate expands more than the second substrate or the third substrate, the overlapping range of the mount region of the first terminal group and the third terminal group and the mount region of the second terminal group and the fourth terminal group is narrowed. Accordingly, for an expandable first substrate, the mount region of the second substrate and the third substrate can be set in a narrow range, thus offering the advantage of reducing the width of the outer periphery of the drive region of the electrooptic device.

It is preferable that the first substrate be a flexible wiring board. Since the flexible wiring board changes in size significantly by temperature changes or humidity absorption, the disagreement of the array pitches of the terminals are prone to occur between the electrooptic device and a third electronic component. Thus, the application of the invention offers great advantages.

It is preferable that the thermal expansion coefficient of the first substrate and the thermal expansion coefficients of the second substrate and the third substrate be different. When the second substrate and the third substrate are mounted to the first substrate, the substrates will change in size owing to the difference in thermal expansion coefficient. Thus, the application of the invention offers great advantages of reducing mount failure.

According to a second aspect of the invention, there is provided a wiring board comprising: a first terminal group including a plurality of first terminals, the first terminals extending along a plurality of lines that substantially pass through a first common point apart from the first terminal group in a predetermined direction intersecting the direction of the array of the first terminals; and a second terminal group including a plurality of second terminals, the second terminals extending along a plurality of lines that substantially pass through a second common point apart from the second terminal group in a predetermined direction intersecting the direction of the array of the second terminals.

According to a third aspect of the invention, there is provided a method for manufacturing an electrooptic device including: a first substrate including a first terminal group having a plurality of first terminals and a second terminal group having a plurality of second terminals; a second substrate including a third terminal group having a plurality of third terminals that are conductively connected to the plurality of corresponding first terminals; a third substrate including a fourth terminal group having a plurality of fourth terminals that are conductively connected to the plurality of corresponding second terminals. The plurality of first terminals extend along a plurality of lines passing through a first common point apart from the first terminal group in a predetermined direction intersecting the direction of the array of the first terminals; the plurality of second terminals extend along a plurality of lines passing through a second common point apart from the second terminal group in a predetermined direction intersecting the direction of the array of the second terminals. The thermal expansion coefficient of the first substrate and the thermal expansion coefficients of the second substrate and the third substrate are different. The method comprises: when the first substrate is mounted to the second substrate by thermocompression bonding, adjusting the positions of the first terminal group and the third terminal group according to the difference between the size changes of the first substrate and the second substrate due to a difference in thermal expansion coefficient; and when the first substrate is mounted to the third substrate by thermocompression bonding, adjusting the positions of the second terminal group and the fourth terminal group according to the difference between size changes of the first substrate and the third substrate due to a difference in thermal expansion coefficient.

According to a fourth aspect of the invention, there is provided an electronic device comprising any of the above electrooptic devices. Examples of the electronic device include mobile phones, notebook personal computers, TV receivers, electronic clocks, and liquid crystal projectors.

### BRIEF DESCRIPTION OF THE DRAWINGS

The invention will be described with reference to the accompanying drawings, wherein like numbers reference like elements.

FIG. 1 is a schematic plan view of the entire structure of a first embodiment.

FIG. 2 is a schematic plan view of the entire structure of a second embodiment.

FIG. 3 shows the connecting board of the first embodiment in plan view and sectional view.

FIG. 4 shows another connecting board in plan view and sectional view.

FIG. 5 is a plan view of yet another connecting board.

FIG. 6 is an explanatory diagram of the positional relationship between a first terminal group and a second terminal group.

FIG. 7 is a plan view of a connecting board according to a third embodiment.

FIG. 8 is a plan view of a connecting board according to a fourth embodiment.

FIG. 9A is a schematic perspective view of an example of an electronic device.

FIG. 9B is a schematic perspective view of the electronic device.

### DESCRIPTION OF EXEMPLARY EMBODIMENTS

### First Embodiment

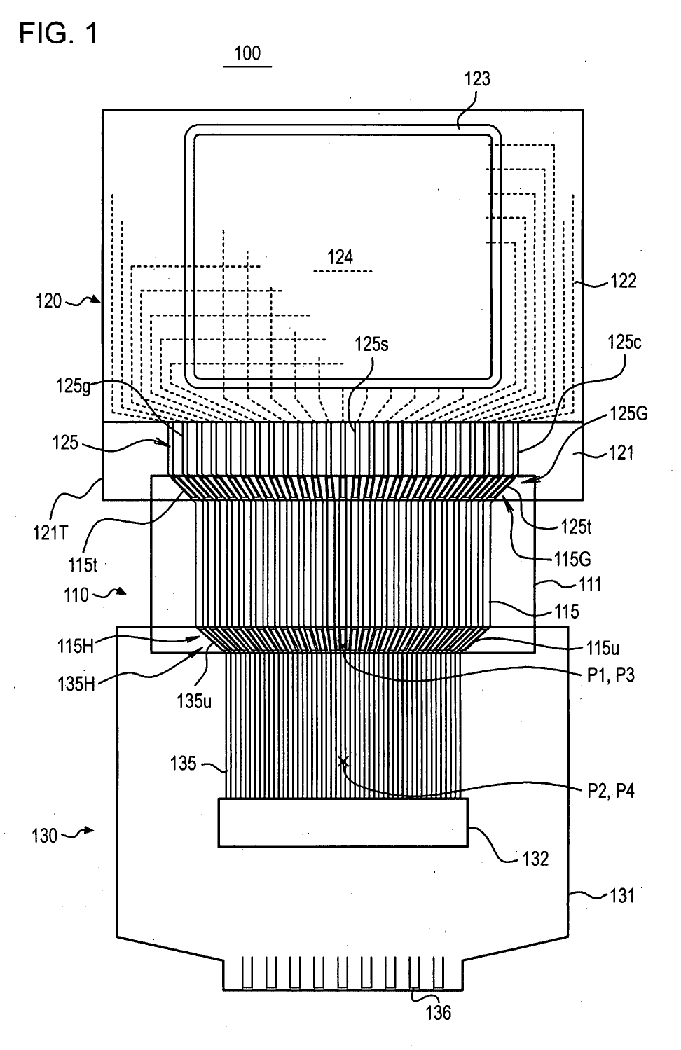

A first embodiment of the invention will be described with reference to the drawings. FIG. 1 is a schematic plan view of the entire structure of an electrooptic device (mount structure) 100 of the first embodiment. The electrooptic device 100 includes a connecting board (a first substrate) 110, an electrooptic panel (an electronic component including a second substrate) 120 connected to the connecting board 110, and a circuit board (a third substrate) connected to the connecting board 110. Although FIG. 1 shows the wires and terminals in such a manner as to be viewed through the connecting board 110 for the convenience of illustration, the board may be opaque.

Preferably, the connecting board 110 is a flexible wiring board whose substrate 111 is made of synthetic resin or the like. The use of the flexible wiring board facilitates connecting the connecting board 110 in an appropriate place without a significant influence of the arrangement or position of the electrooptic panel 120. The connecting board 110 may have various electronic components such as an integrated circuit chip (a semiconductor chip) having a driving circuit.

The connecting board 110 has a plurality of conducting stripe wires 115 made of aluminum or copper on the substrate 111 made of polyimide resin or the like. First ends of the wires 115 are plated with gold in a wiring pattern such that they are exposed on the back of the connecting board 110 to form first terminals 115t. The first terminals 115t are basically arrayed at regular intervals in the lateral direction to form a first terminal group 115G. The first terminal group 115G is arranged along an outer rim of the connecting board 110 (the upper rim in the drawing).

The first terminals 115t extend along a plurality of lines passing through a first common point P1 apart in the direction intersecting the array (the lateral direction). More specifically, in the example illustrated, the first common point P1 is on the center line intersecting the array and passing through the middle point of the array, and the first terminals 115t are arrayed in symmetry about the center line.

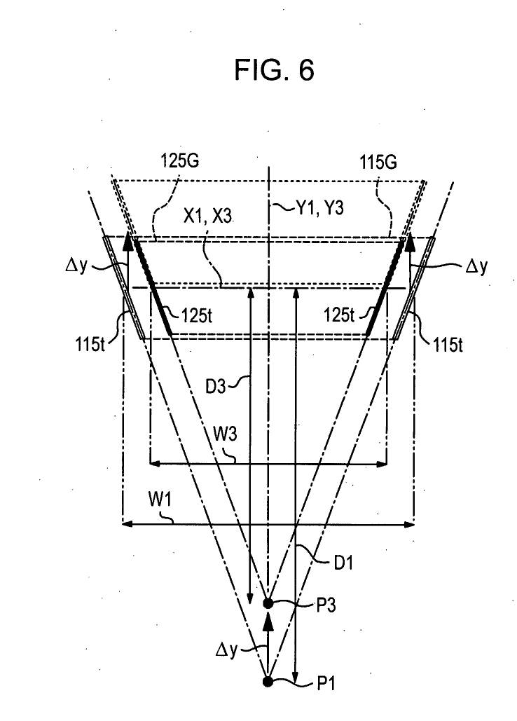

FIG. 6 is an explanatory diagram of the positional relationship between the first terminals 115t and third terminals 125t, to be described later. The figure shows, of the first terminal group 115G, only a pair of first terminals 115t arranged on opposite ends of the array, and omits the other terminals. The first common point P1 is in the position apart from the first terminal group 115G and on a central axis Y1 that intersects an array axis X1 extending along the array of the first terminal group 115G and passing through the middle point of the extension of the first terminals 115t and that passes through the middle point of the array of the first terminal group 115G. All of the first terminals 115t are arrayed in the shape of a belt and extend along a plurality of lines that pass through the first common point P1. Symbol W1 indicates the width of the array of the first terminal group 115G (the total width of the array of the third terminals), and D1 indicates the distance between the array axis X1 and the first common point P1 along the central axis Y1.

Referring back to FIG. 1, a plurality of second terminals 115u at second ends of the wires 115 are arrayed along a second outer rim of the connecting board 110 (an outer rim opposite to the first terminal group 115G, the lower rim in the drawing). The second terminals 115u have the same structure as that of the first terminals 115t, and constitute a second terminal group 115H which are arrayed laterally in the drawing. The second terminal group 115H are also arrayed in the shape of a belt and extend along a plurality of lines passing through a second common point P2 that is apart in the direction intersecting the array. An explanation for the second terminal group 115H will be omitted here because the explanation for the first terminal group 115G in FIG. 6 can be applied to the second terminal group 115H by replacing the first terminals 115t with the second terminals 115u and the first common point P1 with the second common point P2, respectively.

In this embodiment, the first common point P1 is disposed at the outer rim of the connecting board 110 opposite to the first terminal group 115G (at the second terminal group 115H), while the second common point P2 is disposed on the side apart from the connecting board 110 and the second terminal group 115H (opposite to the first terminal group 115G). In other words, the first common point P1 for the first terminal group 115G and the second common point P2 for the second terminal group 115H are disposed on the same side (both are disposed below in the drawing).

On the other hand, the electrooptic panel 120 can achieve desired display by application of an electric field to an electrooptic material. The example illustrated is a liquid-crystal display panel. The electrooptic panel 120 is constructed such that glass or plastic substrates 121 and 122 are bonded together with a sealing member 123 in between, between which liquid crystal 124 is sealed. There are a plurality of electrodes made of a transparent conductor such as indium tin oxide (ITO) arranged on the opposing inner surfaces of the substrates 121 and 122. The opposing electrodes overlap in plan view to form a pixel. The pixels are arrayed laterally and vertically in matrix form.

The electrodes on the substrate 121 are pixel electrodes connected to active elements (e.g., thin-film transistors (TFTs)) connected to selecting wires 125g and data wires 125s, to be described later. The electrodes on the substrate 122 are common electrodes connected to a common wire 125c, to be described later. For the active elements, not only the three-terminal nonlinear elements such as TFTs but also two-terminal nonlinear elements such as thin-film diodes (TFDs) may be used. In such a case, the common electrodes are configured as a plurality of belt-like opposing electrodes.

The substrate 121 has a substrate extending portion 121T extending outward from the substrate 122. Onto the surface of the substrate extending portion 121T, wires 125 connected directly or indirectly to the electrodes are drawn. The wires 125 include the selecting wires 125g for supplying selecting signals (scanning signals and gate signals) to the active elements (TFTs) of the pixels, the data wires 125s for supplying data signals (source signals) to the active elements (TFTs) of the pixels, and one or a plurality of common wires 125c for supplying common potential to the common electrodes. The plurality of wires 125 each have a third terminal 125t at an end at regular intervals. The third terminals 125t configure a third terminal group 125G.

The third terminal group 125G has an array and shape corresponding to the first terminal group 115G. Specifically, under the environment of a specified temperature and humidity, the third terminals 125t are arrayed in the shape of a belt and extend along a plurality of lines passing through a common point P3, and the common point P3 is put in the position where it falls on the first common point P1 when the first terminals 115t agree with the third terminals 125t.

Referring again to FIG. 6, the relationship between the first terminal group 115G and the third terminal group 125G will be described. Of the third terminal group 125G, only a pair of third terminals 125t at the opposite ends of the array is shown and the other third terminals 125t are not shown. The third terminals 125t are arrayed along an array axis X3 on the line connecting the middle points of the third terminals 125t. The common point P3 is disposed on a central axis Y3 intersecting the array axis X3 and passing through the middle point of the array of the third terminal group 125G and apart from the third terminal group 125G. Symbol W3 indicates the width of the array of the third terminal group 125G, and D3 indicates the distance between the array axis X3 and the common point P3 along the central axis Y3.

Under the environment of a specified temperature and humidity, the first terminal group 115G completely agrees with the third terminal group 125G. That is, the array width W1=W3, the distance D1=D3, and the line passing through the first common point P1 that specifies the position and direction of the extension of the first terminals 115t and the line passing through the common point P3 that specifies the position and direction of the extension of the corresponding third terminals 125t have the same angle of inclination.

Suppose the array width W1 of the first terminal group 115G becomes larger than the array width W3 of the third terminal group 125G as the temperature or humidity changes from the above environment (environment at designing). This situation corresponds to a case where, for example, the thermal expansion coefficient of the connecting board 110 is larger than that of the substrate 121 and the temperature become higher than the above environment. Under the situation, even when the array axis X1 of the connecting board 110 and the array axis X3 of the electrooptic panel 120 are put on one another and the central axis Y1 of the connecting board 110 and the central axis Y3 of the electrooptic panel 120 are put one on another (such positioning is easy by the use of a known alignment mark), the first terminals 115t and the corresponding third terminals 125t are not agreed; the first terminals 115t are disposed outside the corresponding third terminals 125t (off the central axes Y1 and Y3 in the direction of the array) except the terminals on the central axes Y1 and Y3). Since the distance D1>D3 holds generally, the first common point P1 is disposed in the position apart from the first terminal group 115G and the third terminal group 125G as compared with the common point P3.

Thus the connecting board 110 is moved to the electrooptic panel 120 along the central axes Y1 and Y3 in the direction in which the first common point P1 shifts to the common point P3. Thus, the array axis X1 shifts higher than the array axis X3 so that all the first terminals 115t are put on the corresponding third terminals 125t. FIG. 6 shows that the first terminal group 115G completely agree with the third terminal group 125G by shifting the connecting board 110 to the electrooptic panel 120 along the central axes Y1 and Y3 by distance Δy.

Referring back again to FIG. 1, a circuit board 130 is constructed such that patterned wires 135 made of copper or the like are formed on a substrate 131 made of a hard material such as glass epoxy resin or phenol resin, and a semiconductor chip serving as a driving circuit and another electronic component 132 are mounted. The circuit board 130 can output a driving signal to the electrooptic panel 120 when specified control signals and data signals are input to a plurality of input terminals 136.

A fourth terminal group 135H corresponding to the second terminal group 115H is disposed at part of the outer rim of the circuit board 130. The fourth terminal group 135H has a plurality of fourth terminals 135u at ends of the wires 135 in such a manner as to be in the position, shape, and array corresponding to the second terminals 115u of the second terminal group 115H. The fourth terminals 135u are arrayed in the shape of a belt and extend along a plurality of lines passing through a common point P4 that is apart in the direction intersecting the array of the fourth terminal group 135H.

The relationship between the second terminal group 115H and the fourth terminal group 135H is completely the same as that between the first terminal group 115G and the third terminal group 125G. The explanation for the relationship between the second terminal group 115H and the fourth terminal group 135H will be omitted here because the description for the relationship between the first terminal group 115G and the third terminal group 125G can be applied by replacing the first terminal group 115G with the second terminal group 115H, the first terminals 115t with the second terminals 115u, the third terminal group 125G with the fourth terminal group 135H, and the third terminals 125t with the fourth terminal 135t, respectively.

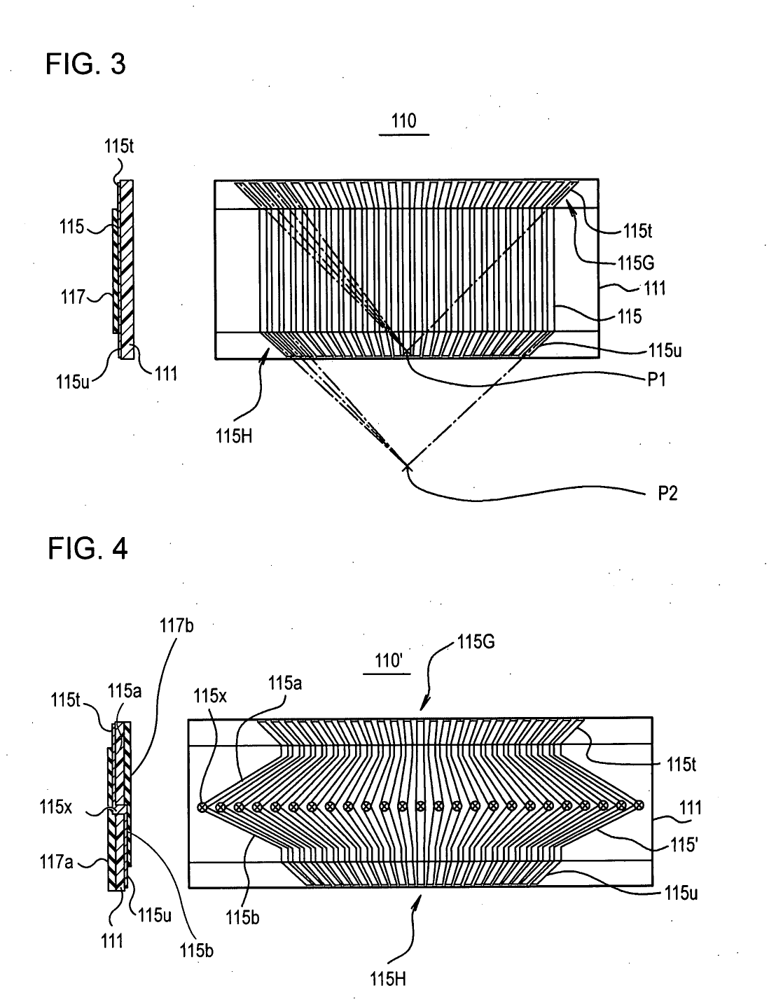

FIG. 3 shows the connecting board 110 in plan view and sectional view. The connecting board 110 has a structure in which the wires 115 made of copper or aluminum are formed on the substrate 111 made of polyimide resin or the like, the part of which except the opposing first terminals 115t and second terminals 115u are coated with an insulating film 117 made of insulating resist or the like. It is preferable that the first terminals 115t and the second terminals 115u is coated with high-conductivity surface coating such as gold plating.

FIG. 4 shows another connecting board 110′, as a substitute for the connecting board 110, in plan view and sectional view. The connecting board 110′ is constructed such that the first terminal group 115G is formed on one surface of the substrate 111, and the second terminal group 115H is formed on the other surface of the substrate 111. This structure is for a case in which, in the electrooptic device (mount structure) 100, the mount surface of the electrooptic panel 120 and the mount surface of the circuit board 130 for the connecting board 110 are opposite between the front and back in such a manner that the back of an end of the connecting board 110 faces the front of the substrate 121 of the electrooptic panel 120, and the front of the end of the connecting board 110 faces the back of the circuit board 130.

The wires 115′ of the connecting board 110′ includes wire portions 115a having the first terminals 115t at the ends and formed on one surface of the substrate 111 and wire portions 115b having the second terminals 115u at the ends and formed on the other surface of the substrate 111. The wire portions 115a and the wire portions 115b are conductively connected to each other through front-back conducting portions 115x in through holes of the substrate 111. The part of the wire portions 115a other than the first terminals 115t is coated with an insulating film 117a formed on one surface of the substrate 111, while the part of the wire portions 115b other than the second terminals 115u is coated with an insulating film 117b formed on the other surface of the substrate 111. In that case, when the pitches of the first terminals 115t and the second terminals 115u are small, and the pitch of the wires 115 is set to be similar to the terminal pitches, so that the insulation between the front-back conducting portions 115x is difficult, it is preferable to set the array pitch of the front-back conducting portions 115x larger than the terminal pitches by expanding the plane pattern of the wire portions 115a and 115b, as shown in the drawing.

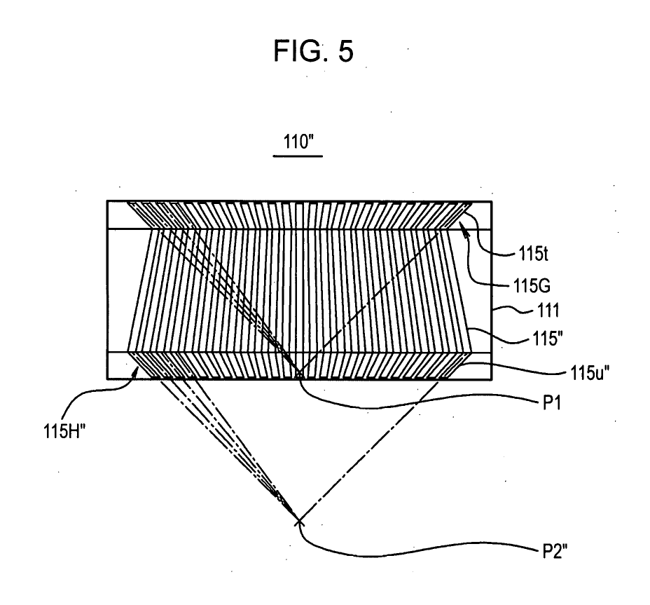

FIG. 5 is a plan view of another connecting board 110″. The connecting board 110″ is constructed such that the array pitch of the first terminals 115t of the first terminal group 115G and that of second terminals 115u″ of a second terminal group 115H″ are substantially the same. To this end, the plane pattern of wires 115″ is constructed such that the array pitch expands gradually from the base of the first terminal group 115G to the base of the second terminal group 115H″. The first terminal group 115G and the second terminal group 115H″ may have completely the same array and shape. In this case, the positional relationship between the first terminal group 115G and the first common point P1 and that between the second terminal group 115H″ and a second common point P2″ are completely the same (congruent). This arrangement allows the array pitches of the first terminal group 115G and the second terminal group 115H″ to be optimized to the size and shape of the electrooptic device 100, thus enabling both electrical reliability and miniaturization of the device (narrowing of the terminal pitch) to be achieved at high level.

In this embodiment, the connecting board 110 includes the first terminal group 115G for connecting to the electrooptic panel 120 and the second terminal group 115H″ for connecting to the circuit board 130, and the first terminal group 115G has the belt-like first terminals 115t extending along the plurality of lines passing through the first common point P1 and the second terminal group 115H″ has the belt-like second terminals 115u″ extending along the plurality of lines passing through the second common point P2″. Accordingly, even if the terminals in the respective mount regions are arrayed with a narrow pitch, mount failure arising from disagreement between the terminals caused by size changes due to temperature or humidity changes can be prevented, so that the electrical reliability of the device can be improved.

Since the first terminal group 115G is formed at an outer rim of the connecting board 110, and the second terminal group 115H″ is formed at the opposite outer rim, the positioning of the mount region of the first terminal group 115G and the third terminal group 125G (the agreement between the array axes X1 and X3, the agreement between the central axes Y1 and Y3, and the positioning along the central axes Y1 and Y3) and the positioning of the mount region of the second terminal group 115H″ and the fourth terminal group 135H (the same positioning as the above) can be set substantially in the same direction, improving the workability of mounting.

Furthermore, the first common point P1 for the first terminal group 115G and the second common point P2″ for the second terminal group 115H″ are disposed on the same side (below in the drawing). Accordingly, if the connecting board 110 expands relative to the electrooptic panel 120 and the circuit board 130 more than that at designing because of changes in environment, the range in which the connecting board 110 overlaps with the electrooptic panel 120 along the central axes Y1 and Y3 needs to be increased so as to agree the first terminal group 115G with the third terminal group 125G, while the range in which the pixel electrode 10 overlaps with the circuit board 130 needs to be decreased so as to agree the second terminal group 115H″ with the fourth terminal group 135H.

Thus, in adjusting the disagreement of the terminal pitch due to environmental change, changes in the length from the electrooptic panel 120 through the connecting board 110 to the circuit board 130 can be reduced because there is an inverse relationship between the fluctuation in the overlapping range of the mount region of the first terminal group 115G and the third terminal group 125G and the fluctuation in the overlapping range of the mount region of the second terminal group 115H″ and the fourth terminal group 135H. Thus, the size change of the entire electrooptic device 100 can be reduced. Therefore, variations in the size of the electrooptic device 100 can be reduced, thus preventing the occurrence of failure due to variations in size when mounting the electrooptic device 100 to an electronic device or the like.

### Second Embodiment

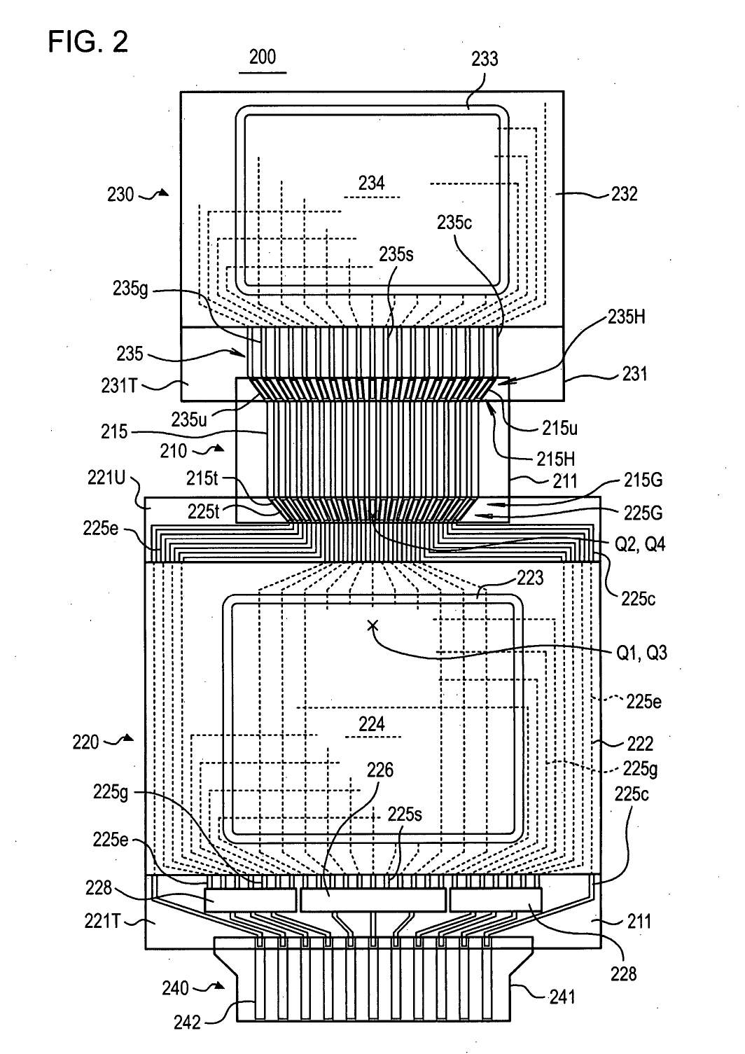

A second embodiment of the invention will next be described with reference to FIG. 2. An electrooptic device 200 according to the second embodiment has a structure in which an electrooptic panel 220 including a second substrate and an electrooptic panel 230 including a third substrate are connected to a connecting board 210 or a first substrate.

In this embodiment, the connecting board 210 has on its substrate 211 a plurality of wires 215, as in the first embodiment, a first terminal group 215G including a plurality of first terminals 215t at a first end of the wires 215, and a second terminal group 215H including a plurality of second terminals 215u at a second end of the wires 215. Like the connecting board 110 of the first embodiment, the first terminal group 215G has a terminal array specified by a first common point Q1, and the second terminal group 215H has a terminal array specified by a second common point Q.

However, the connecting board 210 of this embodiment is different from the connecting board 110 of the first embodiment in the following point: the first embodiment is constructed such that both the first common point P1 for the first terminal group 115G and the second common point P2 for the second terminal group 115H are disposed opposite to the electrooptic panel 120; on the other hand, the second embodiment is constructed such that the first common point Q1 for determining the array and shape of the first terminal group 215G and the second common point Q2 for determining the array and shape of the second terminal group 215H are disposed apart on the side of the electrooptic panel 220 including the second substrate. However, the first embodiment may be constructed like the second embodiment; conversely, the second embodiment may be constructed like the first embodiment.

The electrooptic panel 220 of this embodiment is constructed such that substrates 221 and 222 are bonded together with a sealing member 223 in between, between which liquid crystal 224 is sealed. Onto a substrate extending portion 221T, wires 225 are drawn. The wires 225 are conductively connected to a data-line driving circuit 226 and two scanning-line driving circuits 228 mounted on the substrate extending portion 221T. The data-line driving circuit 226 and the scanning-line driving circuits 228 receive input signals via a connecting board 240 mounted on the substrate extending portion 221T. The connecting board 240 has a plurality of wires 242 on its substrate 241. The wires 242 are conductively connected to input terminals at ends of the wires 225.

The wires 225 include data wires 225s conductively connected to the data-line driving circuit 226, selecting wires 225g conductively connected to the scanning-line driving circuits 228, selecting wires 225e conductively connected to the scanning-line driving circuits 228, and common wires 225c connected directly to the input terminals. The selecting wires 225g and the data wires 225s are introduced into the drive region of the electrooptic panel 220 in the intersecting directions and are connected to the lines and rows of the active elements (three-terminal nonlinear elements such as TFTs) provided for the pixels arrayed in matrix form in the drive region. The common wires 225c are connected to common electrodes opposed to pixel electrodes connected to the active elements.

The electrooptic panel 220 has a substrate extending portion 221U at the rim opposite to the substrate extending portion 221T. Onto the substrate extending portion 221U, the selecting wires 225e, the data wires 225s, and the common wires 225c are drawn. The selecting wires 225e are drawn out to the substrate extending portion 221U through the peripheral region separately from the selecting wires 225g introduced into the drive region of the electrooptic panel 220. The data wires 225s are introduced into the drive region and extend to the opposite side of the drive region into the substrate extending portion 221U. The common wires 225c are conductively connected to the common electrodes in the drive region and pass through the periphery of the substrate onto the substrate extending portion 221U.

The substrate extending portion 221U has thereon a third terminal group 225G including a plurality of third terminals 225t at ends of the selecting wires 225e, the data wires 225s, and the common wires 225c. The third terminals 225t of the third terminal group 225G are arrayed in the shape of a belt and extend along a plurality of lines that pass through a common point Q3 so as to have an array and shape corresponding to the first terminals 215t of the first terminal group 215G and are conductively connected to the corresponding first terminals 215t.

The electrooptic panel 230 including the third substrate is constructed such that substrates 231 and 232 are bonded together with a sealing member 233 in between, between which liquid crystal 234 is sealed. Onto a substrate extending portion 231T, wires 235 are drawn. The wires 235 have fourth terminals 235u at the ends thereof. The fourth terminals 235u are arranged along the outer rim of the substrate extending portion 231T to form a fourth terminal group 235H.

The wires 235 include selecting wires 235g, data wires 235s, and common wires 235c introduced into the drive region of the electrooptic panel 230. Both the selecting wires 235g and the data wires 235s are connected to active elements provided for pixels arrayed in matrix form in the drive regions. The common wires 235c are conductively connected to common electrodes facing the pixel electrodes connected to the active elements. The fourth terminals 235u are arrayed in the shape of a belt and extend along a plurality of lines passing through a common point Q4 so as to have an array and shape corresponding to the second terminal group 215H and are conductively connected to the corresponding second terminals 215u.

With the mount structure of the second terminal group 215H and the fourth terminal group 235H, the selecting wires 225e are conductively connected to the selecting wires 235g, the data wires 225s are conductively connected to the data wires 235s, and the common wires 225c are conductively connected to the common wires 235c.

In this embodiment, the data signals output from the data-line driving circuit 226 are supplied to the pixels in the drive region of the electrooptic panel 220 through the data wires 225s, and also to the pixels in the drive region of the electrooptic panel 230 through the connecting board 210 and the data wires 235s. Part of the selecting signals output from the scanning-line driving circuits 228 pass through the selecting wires 225e and the connecting board 210 into the selecting wires 235g, and are supplied to the pixels in the drive region of the electrooptic panel 230. Thus, although different scanning signals are supplied to the electrooptic panels 220 and 230, the same data signals are supplied thereto, so that the electrooptic panels 220 and 230 are driven according to the same data signals.

Accordingly, in this embodiment, the electrooptic panels 220 and 230 can be driven by the common data-line driving circuit 226 and scanning-line driving circuits 228. In the example illustrated, all the data wires 225s for supplying data signals to the drive region of the electrooptic panel 220 are conductively connected to the data wires 235s for supplying data signals to the drive region of the electrooptic panel 230. However, if the number of display pixels of the electrooptic panel 230 is smaller than that of the electrooptic panel 220, only part of the data wires 225s may be conductively connected to the data wires 235s.

### Third Embodiment

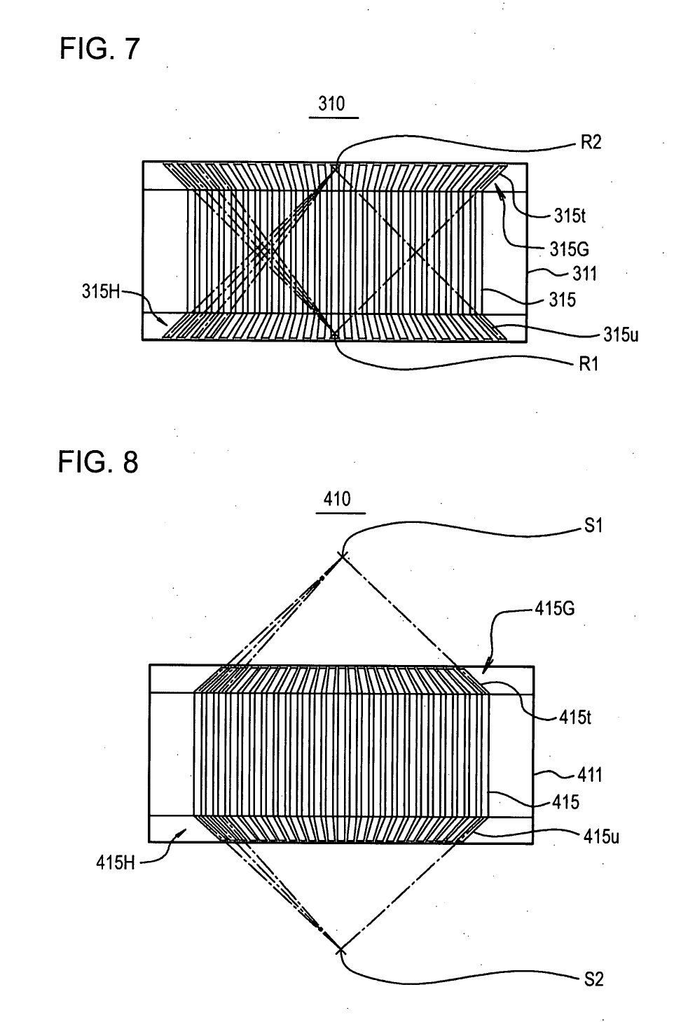

Referring next to FIG. 7, a connecting board 310 according to a third embodiment of the invention will be described. FIG. 7 is a plan view of the connecting board 310. The connecting board 310 can be used in place of either the connecting board 110 according to the first embodiment or the connecting board 210 according to the second embodiment.

The connecting board 310 includes a plurality of wires 315 on its substrate 311, and also a first terminal group 315G including a plurality of first terminals 315t at first ends of the wires 315 and a second terminal group 315H including a plurality of second terminals 315u at second ends of the wires 315. The structures of the first terminal group 315G and the second terminal group 315H are basically the same as those of the first and second embodiments. However, in the third embodiment, a first common point R1 that specifies the direction in which the first terminals 315t of the first terminal group 315G extend is disposed at the outer rim of the connecting board 310 opposite to the first terminal group 315G (on the side of the second terminal group 315H); similarly, a second common point R2 that specifies the direction in which the second terminals 315u of the second terminal group 315H extend is disposed at the outer rim of the connecting board 310 opposite to the second terminal group 315H (on the side of the first terminal group 315G). That is, both the first terminal group 315G and the second terminal group 315H are arrayed to expand at ends.

In this embodiment, the first terminal group 315G and the second terminal group 315H are vertically symmetric (with the same array pitch). Thus, the use of either the first terminal group 315G or the second terminal group 315H formed on the upper and lower outer rims of the connecting board 310, respectively, allows the same mounting form, thus improving mounting workability.

To solve the disagreement between the connecting board 310 and the terminal group on the member being mounted due to size change of the connecting board 310 by positional adjustment, fluctuations in the vertical length of the connecting board 310 (the distance between the first terminal group 315G and the second terminal group 315H) and fluctuations in the overlapping range of the mount region correspond to each other. For example, when the vertical length of the connecting board 310 increases, the array pitches of the first terminal group 315G and the second terminal group 315H also expand. Therefore, as in FIG. 6, adjusting the position so as to more widely overlap the connecting board 310 on the member being mounted allows the terminal arrays to agree to each other. Accordingly, fluctuations in the vertical length of the connecting board 310 can be compensated by fluctuations in the overlapping range of the mount regions of the first terminal group 315G and the second terminal group 315H at the upper and lower rims, thus reducing the fluctuations in the vertical length of the entire device comprising the members being mounted (second and third substrates, not shown) connected to the upper and lower rims of the connecting board 310.

### Fourth Embodiment

Referring next to FIG. 8, a connecting board 410 according to a fourth embodiment of the invention will be described. FIG. 8 is a plan view of the connecting board 410. The connecting board 410 can be used in place of either the connecting board 110 according to the first embodiment or the connecting board 210 according to the second embodiment.

The connecting board 410 includes a plurality of wires 415 on its substrate 411, and also a first terminal group 415G including a plurality of first terminals 415t at first ends of the wires 415 and a second terminal group 415H including a plurality of second terminals 415u at second ends of the wires 415. The structures of the first terminal group 415G and the second terminal group 415H are basically the same as those of the foregoing embodiments. However, in the fourth embodiment, a first common point S1 that specifies the direction in which the first terminals 415t of the first terminal group 415G extend is disposed apart from the connecting board 410 with respect to the first terminal group 415G; similarly, a second common point S2 that specifies the direction in which the second terminals 415u of the second terminal group 415H extend is disposed apart from the connecting board 410 with respect to the second terminal group 415H. That is, both the first terminal group 415G and the second terminal group 415H are arrayed in such a way as to narrow at ends.

In this embodiment, the first terminal group 415G and the second terminal group 415H are vertically symmetric (with the same array pitch). Thus, the use of either the first terminal group 415G or the second terminal group 415H formed on the upper and lower outer rims of the connecting board 410, respectively, allows the same mounting form, thus improving mounting workability.

To solve the disagreement between the connecting board 410 and the terminal group on the member being mounted due to size change of the connecting board 410 by positional adjustment, if the array pitches of the first terminal group 415G and the second terminal group 415H of the connecting board 410 are larger than those of the terminal groups of the substrates to be mounted, the terminal arrays can be agreed to each other by adjusting the position so as to narrow the overlapping range of the connecting board 410 to the members being mounted, in contrast to the first embodiment. Thus, the range of the mount region of the connecting board 410 and the member being mounted (second and third substrates) can be reduced, thus reducing the size of the substrates and the width of the peripheral region of the electrooptic panel.

Electronic Device

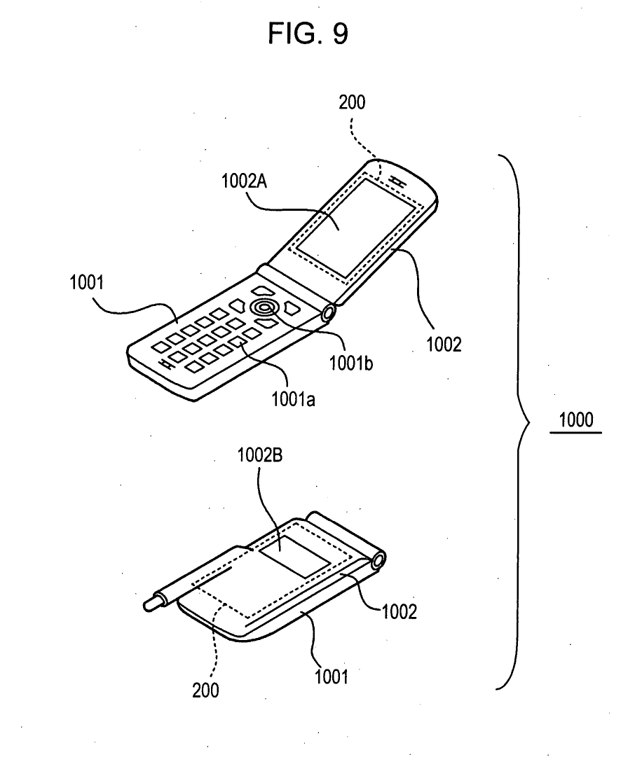

FIGS. 9A and 9B show a mobile phone, denoted by numeral 1000, which is an electronic device according to another embodiment of the invention. The mobile phone 1000 includes an operating section 1001 having a plurality of operation buttons 1001a and 1001b and a mouthpiece and a display section 1002 having display screens 1002A and 1002B and an earpiece, the display section 1002 having the electrooptic device 200 therein. The operating section 1001 and the display section 1002 are foldable. FIG. 9A shows its unfolded state and FIG. 9B shows its folded state.

The electrooptic device 200 is built in the display section 1002 in such a manner that the electrooptic panel 220 and the electrooptic panel 230 are back to back when the connecting board 210 is bent. Between the electrooptic panels 220 and 230 is disposed a backlight as necessary. A display image formed by the electrooptic panel 220 can be viewed on the display screen 1002A on the inner surface of the display section 1002, and a display image formed by the electrooptic panel 230 can be viewed on the display screen 1002B on the outer surface of the display section 1002.

It is needless to say that the electrooptic device, the mount structure, the connecting board, and the electronic device of the invention are not limited to the examples illustrated and that various modifications may be made without departing from the spirit and scope of the invention. For example, although the electrooptic devices according to the embodiments include an electrooptic panel that configures a liquid crystal display, the invention may use not only the liquid crystal display but also various electrooptic panels such as organic electroluminescent displays, electrophoresis displays, and plasma display panels. The invention may be applied not only to the electrooptic device including the electrooptic panel but also to various mount structures having a structure in which one substrate is connected to two or more substrates such as a mount structure in which a connecting board and a circuit board are connected together.

What is claimed is:

1. An electrooptic device comprising:
a first substrate including a first terminal group having a plurality of first terminals and a second terminal group having a plurality of second terminals;
a second substrate including a third terminal group having a plurality of third terminals that are conductively connected to the plurality of corresponding first terminals; and
a third substrate including a fourth terminal group having a plurality of fourth terminals that are conductively connected to the plurality of corresponding second terminals; wherein
the plurality of first terminals extend along a plurality of lines passing through a first common point apart from the first terminal group in a predetermined direction intersecting the direction of the array of the first terminals and are arrayed in line symmetry about an axis passing through the first common point; and
the plurality of second terminals extend along a plurality of lines passing through a second common point apart from the second terminal group in a predetermined direction intersecting the direction of the array of the second terminals and are arrayed in line symmetry about an axis passing through the second common point.

2. The electrooptic device according to claim 1, wherein the first terminal group and the second terminal group are disposed along the opposite outer rims of the first substrate.

3. The electrooptic device according to claim 2, wherein the first common point apart from the first terminal group and the second common point apart from the second terminal group are disposed on the same side.

4. The electrooptic device according to claim 2, wherein the first common point apart from the first terminal group and the second common point apart from the second terminal group are disposed on the opposite sides.

5. The electrooptic device according to claim 4, wherein the first common point for the first terminal group is disposed on the side of the second terminal group, and the second common point for the second terminal group is disposed on the side of the first terminal group.

6. The electrooptic device according to claim 4, wherein the first common point for the first terminal group and the second common point for the second terminal group are apart from the first substrate.

7. The electrooptic device according to claim 1, wherein the first substrate is a flexible wiring board.

8. The electrooptic device according to claim 1, wherein the thermal expansion coefficient of the first substrate and the thermal expansion coefficients of the second substrate and the third substrate are different.

9. A wiring board comprising:
a first terminal group including a plurality of first terminals, the first terminals extending along a plurality of lines that substantially pass through a first common point apart from the first terminal group in a predetermined direction intersecting the direction of the array of the first terminals; and
a second terminal group including a plurality of second terminals, the second terminals extending along a plurality of lines that substantially pass through a second common point apart from the second terminal group in a predetermined direction intersecting the direction of the array of the second terminals.

10. A method for manufacturing an electrooptic device including: a first substrate including a first terminal group having a plurality of first terminals and a second terminal group having a plurality of second terminals; a second substrate including a third terminal group having a plurality of third terminals that are conductively connected to the plurality of corresponding first terminals; a third substrate including a fourth terminal group having a plurality of fourth terminals that are conductively connected to the plurality of corresponding second terminals; wherein
the plurality of first terminals extend along a plurality of lines passing through a first common point apart from the first terminal group in a predetermined direction intersecting the direction of the array of the first terminals;
the plurality of second terminals extend along a plurality of lines passing through a second common point apart from the second terminal group in a predetermined direction intersecting the direction of the array of the second terminals; and
the thermal expansion coefficient of the first substrate and the thermal expansion coefficients of the second substrate and the third substrate are different;
wherein the method comprising:
when the first substrate is mounted to the second substrate by thermocompression bonding, adjusting the positions of the first terminal group and the third terminal group according to the difference between the size changes of the first substrate and the second substrate due to a difference in thermal expansion coefficient; and
when the first substrate is mounted to the third substrate by thermocompression bonding, adjusting the positions of the second terminal group and the fourth terminal group according to the difference between size changes of the first substrate and the third substrate due to a difference in thermal expansion coefficient.

11. An electronic device comprising the electrooptic device according to claim 1.
